(19) United States
(12) Patent Application Publication
(10) Pub. No.: US 2026/0051640 A1
(43) Pub. Date: Feb. 19, 2026

(54) TRACTION BATTERY PACK PORT ASSEMBLY

(71) Applicant: Ford Global Technologies, LLC, Dearborn, MI (US)

(72) Inventors: Rajaram Subramanian, Ann Arbor, MI (US); Steve Droste, Canton, MI (US); Hari Krishna Addanki, Novi, MI (US); Kevin A. Montgomery, Royal Oak, MI (US); Samir Subba, Dearborn, MI (US)

(21) Appl. No.: 18/804,647

(22) Filed: Aug. 14, 2024

(51) Int. Cl. H01M 50/636

(52) U.S. Cl. CPC H01M 50/636; H01M 2220/20

(57) ABSTRACT

A traction battery pack port assembly includes an inner spigot that is securable in an installed position relative to an enclosure. The inner spigot is connectable to a battery pack conduit at a position inside the enclosure when the inner spigot is in the installed position. A fastener has an aperture that receives a portion of the inner spigot and secures the inner spigot to the enclosure. An outer spigot is removably securable to the inner spigot.

### TECHNICAL FIELD

This disclosure relates generally to a port assembly of a traction battery pack and, more particularly, to a port assembly having a spigot that can be serviced from outside an enclosure of the battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. Various fluids, such as coolants and lubricants, can communicate to and from the traction battery pack.

### SUMMARY

In some aspects, the techniques described herein relate to a traction battery pack port assembly, including: an inner spigot that is securable in an installed position relative to an enclosure, the inner spigot connectable to a battery pack conduit at a position inside the enclosure when the inner spigot is in the installed position; a fastener having an aperture that receives a portion of the inner spigot and secures the inner spigot to the enclosure; and an outer spigot removably securable to the inner spigot.

In some aspects, the techniques described herein relate to a traction battery pack port assembly, wherein the outer spigot is secured to the inner spigot with a twist-lock.

In some aspects, the techniques described herein relate to a traction battery pack port assembly, wherein the fastener is a nut.

In some aspects, the techniques described herein relate to a traction battery pack port assembly, wherein the nut is a hex nut.

In some aspects, the techniques described herein relate to a traction battery pack port assembly, wherein the fastener engages an external thread of the inner spigot when securing the inner spigot to the enclosure.

In some aspects, the techniques described herein relate to a traction battery pack port assembly, wherein the inner spigot includes a tool engagement interface.

In some aspects, the techniques described herein relate to a traction battery pack port assembly, wherein the outer spigot and the inner spigot are fluidly connected when the outer spigot is secured to the inner spigot.

In some aspects, the techniques described herein relate to a traction battery pack port assembly, wherein the fastener engages the inner spigot at a position outside the enclosure.

In some aspects, the techniques described herein relate to a traction battery pack port assembly, wherein an annular portion of the enclosure is clamped between the fastener and an annular flange of the inner spigot when the inner spigot is in the installed position.

In some aspects, the techniques described herein relate to a traction battery pack port assembly, wherein the fastener, the inner spigot, and the outer spigot are concentric with each other when the inner spigot is both secured to the enclosure with the fastener and secured to the outer spigot.

In some aspects, the techniques described herein relate to a traction battery pack port assembly, wherein the inner spigot extends from a position outside the enclosure to a position inside the enclosure when the fastener is securing the inner spigot to the enclosure.

In some aspects, the techniques described herein relate to a traction battery pack port assembly, wherein the inner spigot and the outer spigot are a polymer-based material.

In some aspects, the techniques described herein relate to a traction battery pack port assembly, further including a seal compressed by the fastener against the enclosure when the fastener is securing the inner spigot to the enclosure.

In some aspects, the techniques described herein relate to a traction battery pack port assembly, wherein, when the outer spigot is secured to the inner spigot, the inner spigot and the outer spigot provide a liquid communication path extending between an interior of the enclosure and an area that is outside of the enclosure.

In some aspects, the techniques described herein relate to a traction battery pack port providing method, including: receiving a portion of an inner spigot within an aperture of a fastener; using the fastener to secure the inner spigot in an installed position, the inner spigot secured to an enclosure and connectable to a battery pack conduit at a position inside the enclosure when the inner spigot is in the installed position; and removably securing an outer spigot to the inner spigot when the inner spigot is in the installed position.

In some aspects, the techniques described herein relate to a method, wherein the outer spigot is removably securable to the inner spigot from outside the enclosure.

In some aspects, the techniques described herein relate to a method, further including using a twist-lock to secure the outer spigot to the inner spigot.

In some aspects, the techniques described herein relate to a method, wherein the inner spigot extends from outside the enclosure to inside the enclosure when in the installed position.

In some aspects, the techniques described herein relate to a method, wherein the fastener, the inner spigot, and the outer spigot are concentric with each other when the inner spigot is both secured to the enclosure with the fastener and secured to the outer spigot.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a section view through a portion of the battery pack in FIG. 2 showing a port assembly of the battery pack.

FIG. 4 illustrates an inner spigot from the port assembly of FIG. 3 when the inner spigot is received within an aperture of an enclosure of the battery pack.

FIG. 5 illustrates the inner spigot of FIG. 4 secured to the enclosure in an installed position.

FIG. 6 illustrates an outer spigot moving toward a position where the outer spigot is secured to the inner spigot.

### DETAILED DESCRIPTION

This disclosure details exemplary port assemblies and port providing methods for a traction battery pack. The port assemblies can be secured to an enclosure of the traction battery pack. The port assemblies can each provide a passage through the enclosure to an interior of the traction battery pack. The passage can be used to communicate a fluid to or from the interior. Selected portions of the port assemblies can be detached from outside the traction battery pack enclosure. This can facilitate servicing the port assemblies.

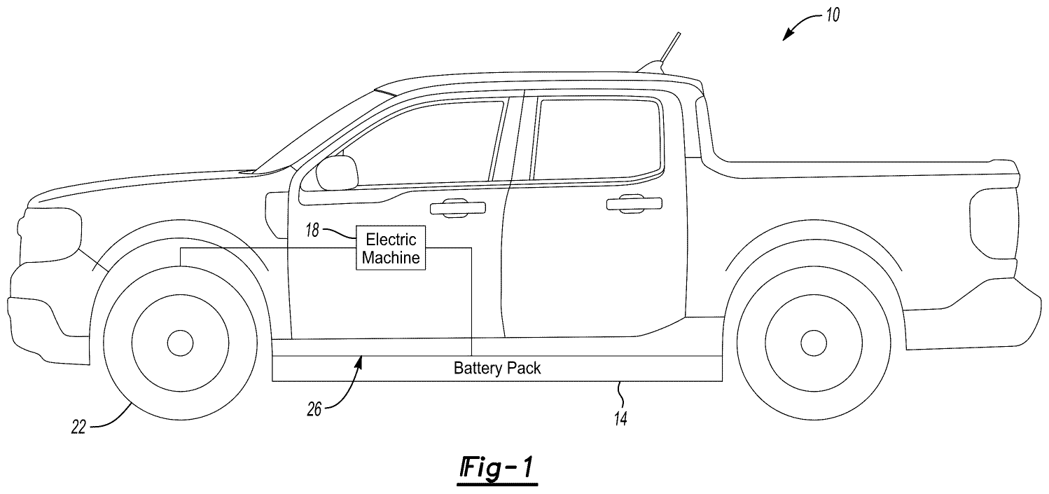

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

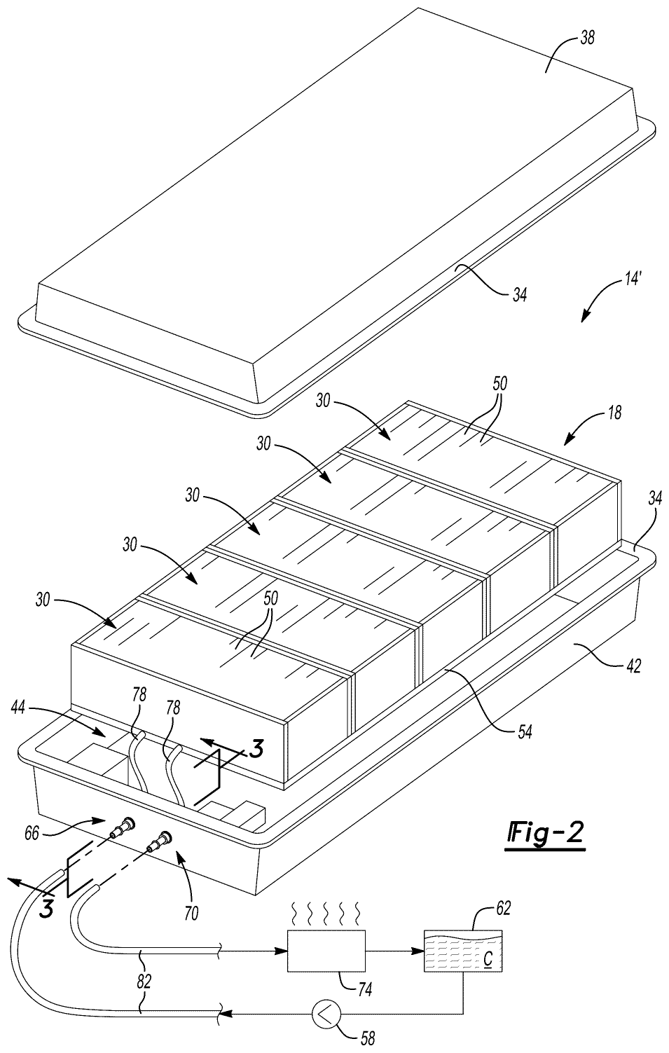

With reference now to FIG. 2, the battery pack 14 includes a plurality of battery arrays 30 held within an enclosure 34. In the exemplary embodiment, the enclosure 34 includes an enclosure cover 38 and an enclosure tray 42. The enclosure cover 38 can be secured to the enclosure tray 42 to provide an interior 44 that houses the battery arrays 30. The enclosure cover 38 can be secured to the enclosure tray 42 using mechanical fasteners (not shown), for example.

Each of the battery arrays 30 includes, among other things, a plurality of battery cells 50 (or simply “cells”) stacked side-by-side relative to each along a respective battery array axis. The battery cells 50 store and supply electrical power. Although a specific number of the battery arrays 30 and cells 50 are illustrated in the various figures of this disclosure, the battery pack 14 could include any number of the battery arrays 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

The example battery cells 50 are disposed upon a thermal exchange plate 54. A coolant can be circulated through the thermal exchange plate 54 to manage thermal energy within the battery cells 50 and other portions of the traction battery pack 14.

In this example, a pump 58 circulates coolant from a coolant supply 62 through a first port assembly 66 to the interior 44 from a position outside the enclosure 34. After taking on thermal energy within the interior 44, the coolant moves through a second port assembly 70 outside the enclosure 34 to a thermal exchange device 74, such as a radiator. The coolant releases thermal energy at the thermal exchange device 74. The coolant then is then returned to the coolant supply 62. The first port assembly 66 and the second port assembly 70 thus, in this example, act as interfaces for communicating liquid coolant to and from the interior of the enclosure 34. The first port assembly 66 and the second port assembly 70 could communicate other liquids in other examples, such as a lubricant.

The battery pack 14 includes battery pack conduits 78 within the interior. One of the battery pack conduits 78 can connect the first port assembly 66 to the thermal exchange plate 54. Another of the battery pack conduits 78 can connect the second port assembly 70 to the thermal exchange plate 54.

Outside the enclosure of the battery pack 14, external conduits 82 can connect pump 58 to the first port assembly 66, and the second port assembly 70 to the thermal exchange device 74.

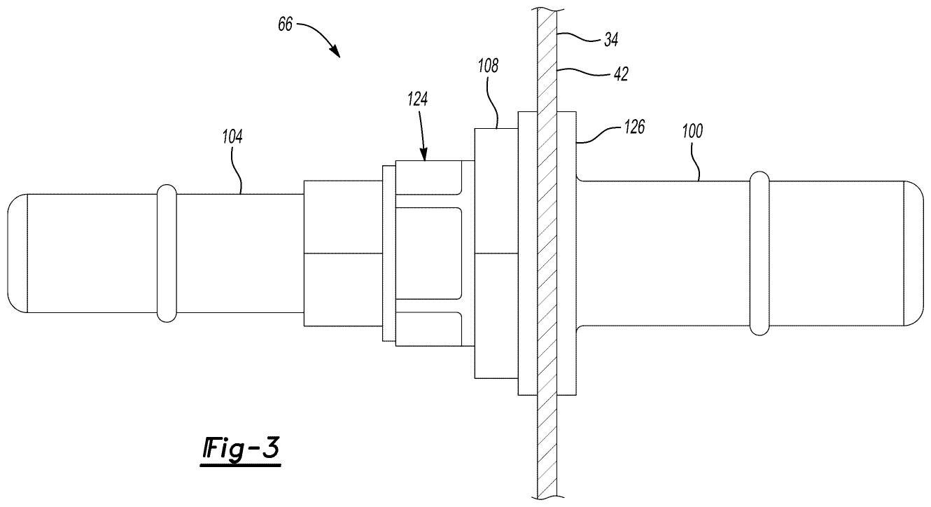

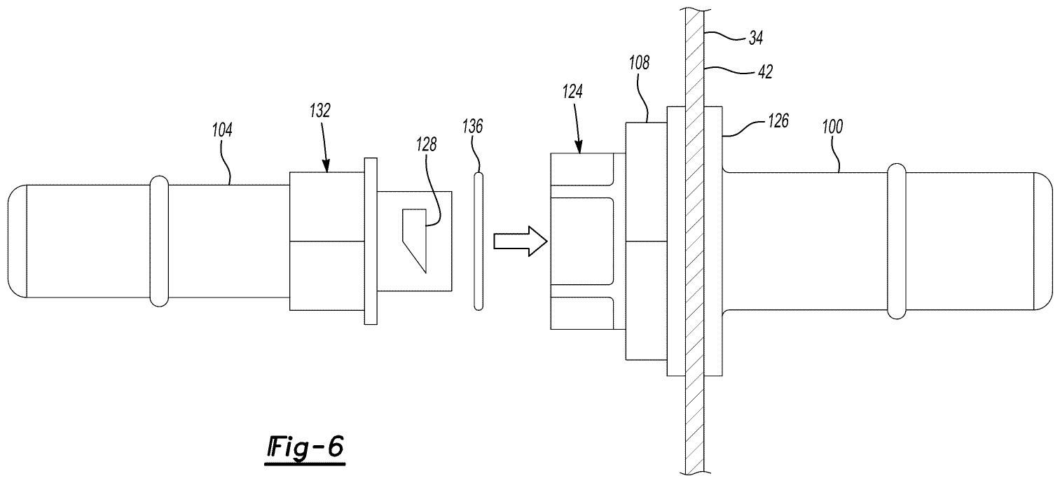

With reference now to FIG. 3-6 and continuing reference to FIG. 2, the first port assembly 66 includes, in this example, an inner spigot 100, an outer spigot 104, and a fastener 108. The inner spigot 100 extends into the interior 44. The inner spigot 100 can connect to one of the battery pack conduits 78 within the interior 44. The outer spigot 104 can connect to one of the external conduits 82 outside the interior 44. The inner spigot 100, the outer spigot 104, and the fastener 108 are a polymer-based material in this example.

The fastener 108 is used to secure the inner spigot 100 to the enclosure 34. The inner spigot 100 is in an installed position when secured to the enclosure 34 as shown in FIG. 3. When the outer spigot 104 is then secured to the inner spigot 100, the inner spigot 100 and the outer spigot 104 provide a liquid communication path extending between the interior 44 and an area that is outside of the enclosure 34.

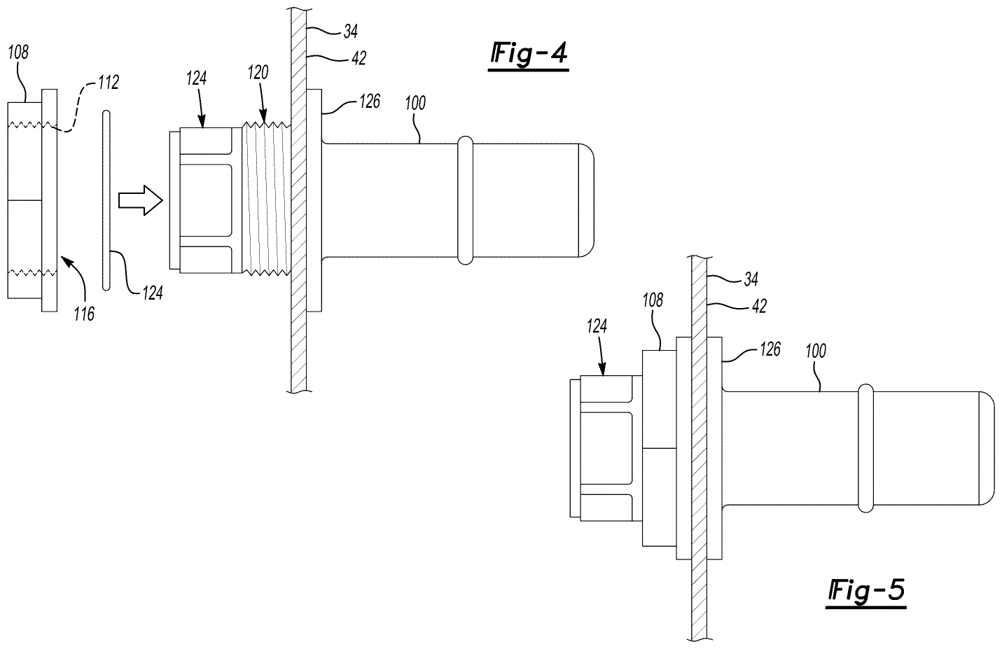

During assembly, the inner spigot 100 is positioned within an aperture of the enclosure 34 as shown in FIG. 4. The inner spigot 100 is then connected to the enclosure 34 using the fastener 108. In this example, the fastener 108 is a hex nut having an internal thread 112 extending about a fastener aperture 116.

The fastener 108 threadably engages an external thread 120 of the inner spigot 100 when securing the inner spigot 100 to the enclosure 34. A seal 124—here an O-ring seal—is compressed against the enclosure 34 as the fastener 108 engages the external thread 120 of the inner spigot 100. The fastener 108 is tightened until the inner spigot 100 is secured to the enclosure 34 as shown in FIG. 5. The inner spigot 100 has a tool engagement interface 124, which can be engaged with a tool to help hold the inner spigot 100 when tightening the fastener 108 using another tool. The tool engagement interface 124 is a hexagonal area, in this example.

With the inner spigot 100 in an installed position, the outer spigot 104 can then be removably secured to the inner spigot 100. The outer spigot 104 and the inner spigot 100 are fluidly connected when the outer spigot 104 is secured to the inner spigot 100. An annular portion of the enclosure 34 is clamped between the fastener 108 and an annular flange 126 of the inner spigot 100 when the inner spigot 100 is in the installed position. The fastener 108, the outer spigot 104, and the inner spigot 100 are concentric with each other when the inner spigot 100 is secured to the enclosure 34 and the outer spigot 104 is secured to the inner spigot 100.

In this example, the outer spigot 104 is removably secured to inner spigot 100 through a twist-lock connection having cams 128 on the outer spigot 104 that are received within corresponding grooves of the inner spigot 100. As the outer spigot 104 is rotated relative to the inner spigot 100, the cams 128 are guided by the grooves within the inner spigot 100 and draw the outer spigot 104 closer to the inner spigot 100. Other connections could be used to removably secure the inner spigot 100 to the enclosure 34 in other examples. For example, in some embodiments, the outer spigot 104 could threadably connect to the inner spigot 100.

The outer spigot 104 can include a tool engagement interface 132 that can be engaged by a tool when securing the outer spigot 104 to the inner spigot 100.

A seal 136 can be compressed between the inner spigot 100 and the outer spigot 104 as the outer spigot 104 is secured.

In an example, the battery pack 14 can be shipped to a location where the battery pack 14 will be assembled into the vehicle 10. The battery pack 14 can be shipped with the inner spigot 100 in the installed position, but with the outer spigot 104 detached from the inner spigot 100. This can reduce a size of the battery pack 14 and a packaging footprint. The battery pack 14, with the outer spigot 104 detached, is also less likely to contact other structures during shipping and assembly.

As the outer spigot 104 is removably secured from a position outside the interior 44, the outer spigot 104 can be repaired, replaced, or otherwise serviced without needing to open the enclosure 34 to access the interior 44.

The second port assembly 70 is configured similarly to the first port assembly 66.

In this example, the fluid communicated through the first port assembly 66 and the second port assembly 70 is coolant that is circulated through the thermal exchange device 74. In other examples, another liquid could communicate through the first port assembly 66 or the second port assembly 70. For example, the liquid could be a dielectric coolant that is used as part of an immersion cooling system for the battery pack 14.

Features of some of the disclosed examples include an outer spigot that can be serviced from outside an enclosure of a battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack port assembly, comprising:
an inner spigot that is securable in an installed position relative to an enclosure, the inner spigot connectable to a battery pack conduit at a position inside the enclosure when the inner spigot is in the installed position;
a fastener having an aperture that receives a portion of the inner spigot and secures the inner spigot to the enclosure; and
an outer spigot removably securable to the inner spigot.

2. The traction battery pack port assembly of claim 1, wherein the outer spigot is secured to the inner spigot with a twist-lock.

3. The traction battery pack port assembly of claim 1, wherein the fastener is a nut.

4. The traction battery pack port assembly of claim 3, wherein the nut is a hex nut.

5. The traction battery pack port assembly of claim 3, wherein the fastener engages an external thread of the inner spigot when securing the inner spigot to the enclosure.

6. The traction battery pack port assembly of claim 3, wherein the inner spigot includes a tool engagement interface.

7. The traction battery pack port assembly of claim 1, wherein the outer spigot and the inner spigot are fluidly connected when the outer spigot is secured to the inner spigot.

8. The traction battery pack port assembly of claim 1, wherein the fastener engages the inner spigot at a position outside the enclosure.

9. The traction battery pack port assembly of claim 8, wherein an annular portion of the enclosure is clamped between the fastener and an annular flange of the inner spigot when the inner spigot is in the installed position.

10. The traction battery pack port assembly of claim 1, wherein the fastener, the inner spigot, and the outer spigot are concentric with each other when the inner spigot is both secured to the enclosure with the fastener and secured to the outer spigot.

11. The traction battery pack port assembly of claim 1, wherein the inner spigot extends from a position outside the enclosure to a position inside the enclosure when the fastener is securing the inner spigot to the enclosure.

12. The traction battery pack port assembly of claim 1, wherein the inner spigot and the outer spigot are a polymer-based material.

13. The traction battery pack port assembly of claim 1, further comprising a seal compressed by the fastener against the enclosure when the fastener is securing the inner spigot to the enclosure.

14. The traction battery pack port assembly of claim 1, wherein, when the outer spigot is secured to the inner spigot, the inner spigot and the outer spigot provide a liquid communication path extending between an interior of the enclosure and an area that is outside of the enclosure.

15. A traction battery pack port providing method, comprising:
receiving a portion of an inner spigot within an aperture of a fastener;
using the fastener to secure the inner spigot in an installed position, the inner spigot secured to an enclosure and connectable to a battery pack conduit at a position inside the enclosure when the inner spigot is in the installed position; and
removably securing an outer spigot to the inner spigot when the inner spigot is in the installed position.

16. The method of claim 15, wherein the outer spigot is removably securable to the inner spigot from outside the enclosure.

17. The method of claim 15, further comprising using a twist-lock to secure the outer spigot to the inner spigot.

18. The method of claim 15, wherein the inner spigot extends from outside the enclosure to inside the enclosure when in the installed position.

19. The method of claim 15, wherein the fastener, the inner spigot, and the outer spigot are concentric with each other when the inner spigot is both secured to the enclosure with the fastener and secured to the outer spigot.
